(19) United States
(12) Patent Application Publication
(10) Pub. No.: US 2010/0194226 A1
(43) Pub. Date: Aug. 5, 2010

(54) MAGNET MODULE FOR A PERMANENT-MAGNET ELECTRICAL MACHINE

(75) Inventors: Torsten Metzner, Berlin (DE); Joachim Risse, Berlin (DE); Hartmut Walter, Berlin (DE); Ralf Wilcke, Berlin (DE); Reinhard Zech, Berlin (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/445,857

(22) PCT Filed: Oct. 11, 2007
(86) PCT No.: PCT/EP2007/060841

§ 371 Date: Apr. 16, 2009

(30) Foreign Application Priority Data
Oct. 17, 2006 (DE) 10 2006 048 966.7

(51) Int. Cl. H02K 1/28

(52) U.S. Cl. 310/156.21

(57) ABSTRACT

An electric machine excited by a permanent magnet, particularly a larger generator of a wind power station, is to be produced and assembled easily. According to the invention, magnetic modules (1) are provided. A rotor can be equipped, for example, with said magnetic modules. Each magnet module (1) comprises a carrier plate (4) for fastening to the rotor, at least one permanent magnet (3), which is disposed on the carrier plate (4), and a covering device (2). The at least one permanent magnet (3) is fastened to the carrier plate (4) such that it is located between the carrier plate (4) and the covering device (2). Advantageously, these magnetic modules (1) can be easily installed or replaced in the gap between the rotor and stator.

The present invention relates to a magnet module for a permanent-magnet electrical machine, which magnet module has a mount and at least one permanent magnet.

In the case of electrical machines with permanent (magnet) excitation, the magnets are generally mounted on the rotor. In the case of linear electrical machines, they are normally attached to the secondary part, but in some cases also to the primary part. The permanent magnets must in this case be protected against environmental influences. Protection against environmental influences is essential in particular in the case of so-called off-shore applications.

One specific requirement relates to the attachment of the permanent magnets to the respective motor part. This attachment must be appropriate for the electrical and mechanical constraints of the respective electrical machine. These are in general magnetic forces, centrifugal forces and assembly options. In addition to simple assembly, the magnet system must also be simple to manufacture, simple to magnetize and, furthermore, simple to replace.

In the case of known permanent-magnet electrical machines, bindings are used for protection against centrifugal forces. It is also known for encapsulation compounds and bindings to be used as additional protection against environmental influences.

By way of example, the document EP 1 439 626 A1 describes an arrangement of permanent magnets for a synchronous machine. There, permanent magnets are fixed over an area and at least one side on a mount material. Furthermore, cuboid permanent magnets, which are embedded in an encapsulation, are arranged in sandwich form between two different mount materials. One of the two mount materials is non-magnetic, and the other mount material is composed of soft-magnetic material.

The object of the present invention is to design the assembly, in particular of a large electrical machine such as a wind power generator, in as simple a form as possible, and thus to propose corresponding machine components.

According to the invention, this object is achieved by a magnet module for a permanent-magnet electrical machine having a mounting plate for attachment to the rotor or to the stator of the electrical machine, at least one permanent magnet which is arranged on the mounting plate and a cover device, by means of which the at least one permanent magnet is mounted on the mounting plate such that it is located between the mounting plate and the cover device.

In particular, magnet modules according to the invention such as these allow simple fitting for example of an unmagnetized rotor with a diameter of 5 meters in the stator. The rotor can easily be centered in this unmagnetized state. After centering and mounting of the rotor, it is fitted with the magnet modules. When necessary, the magnet modules can likewise easily be replaced without having to disassemble the entire electrical machine. This is of major importance in particular for off-shore applications.

A further advantage of the magnet module according to the invention is that the respective magnet modules, that is to say the individual systems, can easily be magnetized for the electrical machine. This is because the magnetization need not be carried out on the rotor or stator.

The cover device preferably covers all the outward-facing surfaces of the at least one permanent magnet which are not covered by the mounting plate. In addition to holding the permanent magnet, this at the same time provides protection against environmental influences.

The cover device may comprise a steel cap. A steel cap such as this has the desired mechanical, electrical and magnetic characteristics.

It is also advantageous for the at least one permanent magnet to be fixed on the mounting plate and/or on the cover device by means of a resin or an adhesive. This not only simplifies the assembly process but also results in additional protection for the permanent magnet against environmental influences.

In addition, the system can be filled with a fillers, in order to protect the system against oscillation influences.

In addition, however, the mounting plate may also have a coating against environmental influences. A coating such as this can be specifically optimized for a specific environmental factor.

According to a further preferred embodiment, the rotor of an electrical machine is equipped with numerous magnet modules, fitted which are on its external circumference, as described above. Specifically, in this case, the cover device can be designed and can be attached to the mounting plate such that it can absorb the majority of the centrifugal forces of the at least one permanent magnet at a predetermined speed of revolution of the electrical machine. By way of example, this makes it possible to dispense with bindings which can be fitted only with relative difficulty to the large rotors of corresponding electrical machines.

Furthermore, it is advantageous for a plurality of the magnet modules to be arranged axially one behind the other on the outer surface of the rotor. In particular, this allows magnets to be fitted easily to a long rotor.

Furthermore, magnet modules can be arranged asymmetrically in the circumferential direction on the rotor. This has the advantage that this reduces the cogging torques.

The present invention will now be explained in more detail with reference to the attached drawings, in which:

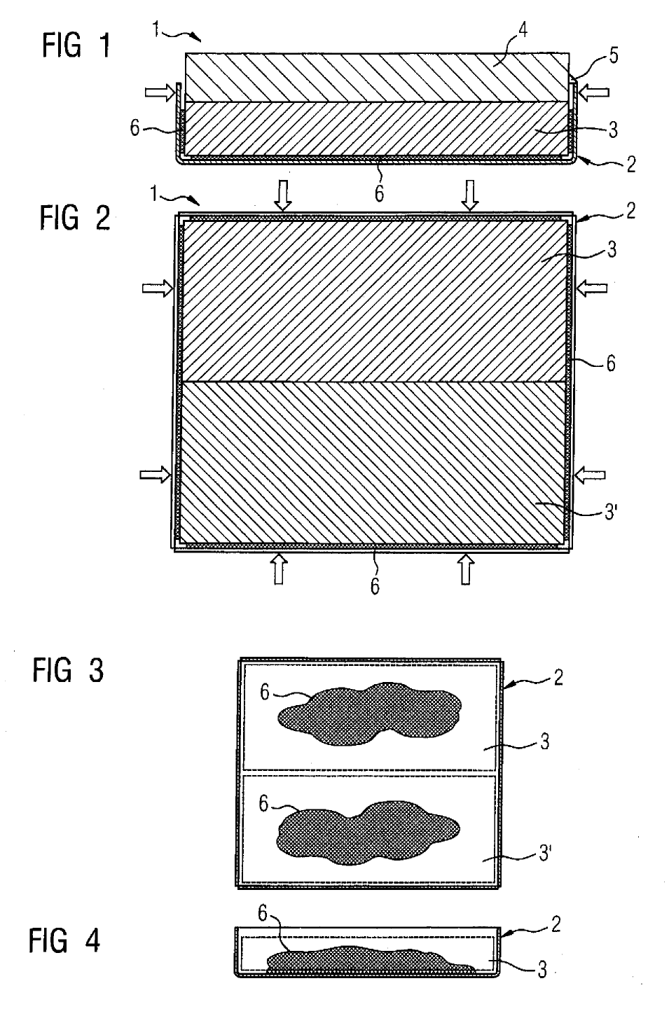

FIG. 1 shows a cross section through a magnet module according to the invention;

FIG. 2 shows a plan view of the magnet module shown in FIG. 1;

FIG. 3 shows a plan view of the inside of the cap before fitting of the magnets;

FIG. 4 shows a cross section through the cap shown in FIG. 3;

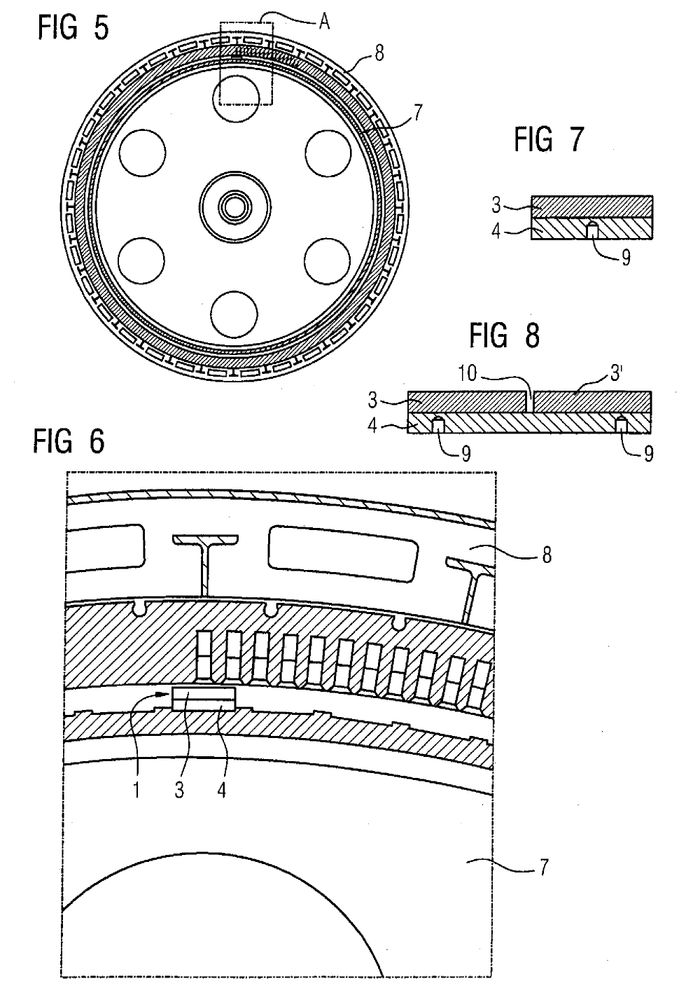

FIG. 5 shows a cross section through an electrical machine;

FIG. 6 shows a detail from FIG. 5;

FIG. 7 shows a cross section through the magnet module shown in FIG. 6, and

FIG. 8 shows an axial longitudinal section through the magnet module shown in FIG. 6.

The exemplary embodiments which are described in more detail in the following text represent preferred embodiments of the present invention.

The magnet module 1, which is illustrated by way of example in FIG. 1, comprises a cap 2 which corresponds to a cuboid container with five walls. During assembly, one or more permanent magnets 3 is or are inserted into the cap 2. A mounting plate 4 is then fitted, and is firmly connected to the cap 2. Appropriate connecting elements 5 are provided on the mounting plate 4 and on the cap 2, for this purpose.

FIG. 2 shows a plan view of the magnet module according to the invention, with the mounting plate 4 not being fitted there. In this case, two permanent magnets 3, 3′ are inserted into the cap 2. Those points at which connecting elements 5 are provided for connection to a mounting plate are identified by an arrow, as in the case of FIG. 1 as well.

FIG. 3 shows a view that is the same as that shown in FIG. 2, but with the magnets removed. An adhesive or filler 6 is applied at the points which correspond approximately to the center areas of the magnets 3, 3′ which are still to be inserted. The magnets 3, 3′ which are still to be inserted are symbolized by dashed lines in FIG. 3.

If the filler 6 is not introduced into the cap 2 over its entire area it can also be applied, as shown in FIG. 4, in the edges and side walls of the cap 2, as a result of which the permanent magnets 3 are also fixed in the horizontal direction, with reference to FIG. 1. The filler 6 can therefore also be seen between the cap 2 and the edge faces of the permanent magnets 3, 3′, in each case, in FIG. 1 and FIG. 2.

The mounting plate 4 for attachment, for example, to a rotor of an electrical machine is composed of an electrically suitable material and can be protected against environmental influences by means of a coating. By way of example, one suitable material is steel, as in the case of the shroud or cap 2. Since the cap 2 is connected to the mounting plate 4, it is used to provide centrifugal-force, environmental-influence or fragment protection for the permanent magnets 3, 3′. The shroud 2 and the connecting elements 5 are also composed of a suitable material, for example metal or plastic. Resin or another adhesive can be used as the adhesive or filler 6.

FIG. 5 shows a cross-section through a rotor 7 and a stator 8 of a permanent-magnet machine. By way of example, a machine such as this is used as a generator in a wind-power installation. Its rotor typically has a diameter of 5 meters.

FIG. 6 shows an enlarged detail A from FIG. 5, where a magnet module 1 is screwed into a corresponding recess in the rotor 7. Specifically, in this case, the mounting plate 4 is screwed to the rotor 7. As shown in FIG. 7 which, like FIG. 1, shows a cross-section through the magnet module, the mounting plate 4 has a thread 9 for this purpose. This FIG. 7 illustrates the magnet module upside down in comparison to the illustration shown in FIG. 1. This orientation of the magnet module 1 also corresponds to that shown in FIG. 6. Specifically, the permanent magnet or magnets 3, 3′ of the magnet module 1 point(s) toward the stator 8 when in the installed state.

FIG. 8 shows a longitudinal section through the magnet module shown in FIG. 7, that is to say in the axial direction of the machine. The mounting plate 4, which is equipped with two threads 9, is in this case fitted with the two permanent magnets 3, 3′. These two permanent magnets 3, 3′ are separated from one another by a gap 10. The gap 10 can be filled with the filler in order to fix the permanent magnets 3, 3′ better with respect to one another.

The magnet module illustrated in FIG. 8 has an axial length of 25 cm, for example, for the already mentioned application in a wind power installation. A correspondingly large number of magnet modules must accordingly be inserted in the axial direction into the rotor/stator gap.

One variant of a rotor, which is not illustrated graphically, may comprise the magnet modules being arranged asymmetrically on the rotor in the circumferential direction. This means that the distances between the magnet modules, when looking at the rotor axially, are not equidistant. For example, every n-th system (wherein the number of poles n must be divisible as an integer) is equidistant, and the magnet modules or magnet systems are shifted through a specific angle between them. This asymmetry reduces the togging torque of the electrical machine.

In the example described above, the mounting plate 4 has approximately the same thickness as the permanent magnets 3, 3′. However, in principle, the ratio of the mounting plate thickness to the magnet thickness can be chosen as required. If required, the mounting plate 4 and the cap 2 form a pure sleeve for the magnet module.

The magnet module according to the invention and a rotor equipped with a magnet module such as this has numerous advantages. One major advantage is that the magnet modules or magnet systems can be fitted when the electrical machine is in the assembled state. This means that, for example, the rotor is inserted into the stator and only then are the permanent magnets or the magnet modules inserted, pushed and/or screwed into the gap between the rotor and the stator. The non-magnetic rotor can thus first of all be mounted in the stator without any risk that the two rest on one another in a manner which makes it virtually impossible to separate them. No special transport system or no special apparatus tube therefore need be provided in order to introduce the rotor into the stator during assembly of the rotor and stator.

The replacement of individual magnet systems or magnet modules can also be carried out easily without having to remove the entire rotor from the machine. This is of major importance in particular in the case of off-shore applications.

A further advantage is that the already-magnetized magnet modules can actually be fitted piece-by-piece, because of the modularity. This makes it possible to simplify the overall process of magnetizing the magnet system. This is because of the fact that the individual systems, that is to say the individual magnet modules, can be magnetized without major hardware complexity. In contrast, if the motor had to be magnetized retrospectively with the magnet modules mounted on it, then a special magnetization arrangement would be required for this purpose.

A further advantage of the magnet modules is that the rotors can be fitted with the magnet modules in a highly flexible manner. In addition to the asymmetric arrangement, it is also possible to create any desired pole gaps, into which appropriate cooling systems can be introduced.

1.-9. (canceled)

10. A magnet module for a permanent-magnet electrical machine, comprising:
a mounting plate constructed for attachment to a rotor or a stator of an electrical machine;
at least one permanent magnet; and
a cover device mounting the at least one permanent magnet on the mounting plate such that the permanent magnet is sandwiched between the mounting plate and the cover device.

11. The magnet module of claim 10, wherein the cover device covers any outward-facing surface of the at least one permanent magnet which is not covered by the mounting plate.

12. The magnet module of claim 10, wherein the cover device is constructed in the form of a steel cap.

13. The magnet module of claim 10, wherein the at least one permanent magnet is fixed to at least one member selected from the group consisting of the mounting plate and the cover device by a resin or an adhesive.

14. The magnet module of claim 10, wherein the mounting plate has a coating against environmental influences.

15. A rotor of an electrical machine, comprising:
a rotor body having an outer circumference; and
plural magnet modules attached to the outer circumference of the rotor body, each said magnet module comprising a mounting plate constructed for attachment to a rotor or a stator of an electrical machine, at least one permanent magnet, and a cover device mounting the at least one permanent magnet on the mounting plate such that the permanent magnet is sandwiched between the mounting plate and the cover device.

16. The rotor of claim 15, wherein the cover device is attached to the mounting plate and constructed to substantially absorb centrifugal forces of the at least one permanent magnet, when the electrical machine rotates at a predefined speed of revolution.

17. The rotor of claim 15, wherein a first plurality of the magnetic modules are arranged axially behind one another on an outer surface of the rotor.

18. The rotor of claim 15, wherein the magnet modules are arranged on the rotor asymmetrically in a circumferential direction.
